(19) United States
(12) Patent Application Publication
(10) Pub. No.: US 2026/0292078 A1
(43) Pub. Date: Sep. 24, 2026

(54) METHOD OF CREATING PRINT PREVIEW, PRINT PREVIEW CREATION DEVICE, AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/403,371

(22) Filed: Nov. 28, 2025

(30) Foreign Application Priority Data
Nov. 28, 2024 (JP) 2024-207040

(51) Int. Cl. H04N 1/00; H04N 1/60

(52) U.S. Cl. CPC H04N 1/0044; H04N 1/6061

(57) ABSTRACT

A method of the disclosure includes (a) acquiring an image color channel representing an image, (b) acquiring medium texture information including a medium color channel representing unevenness of a printing medium and a medium alpha channel representing transparency of the printing medium, (c) calculating an albedo representing reflecting power of a printed matter using the image color channel and the medium alpha channel, (d) creating printed matter color data representing a color of the printed matter using the albedo and the medium color channel, and (e) creating a print preview by synthesizing a background with the printed matter color data using the medium alpha channel without using an alpha channel of the image.

The present application is based on, and claims priority from JP Application Serial Number 2024-207040, filed Nov. 28, 2024, the disclosure of which is hereby incorporated by reference herein in its entirety.

### BACKGROUND

### 1. Technical Field

The present disclosure relates to a method for creating a print preview, a print preview creation device, and a non-transitory computer-readable storage medium storing a computer program.

### 2. Related Art

JP-A-2010-33252 discloses a technique for realistically representing an object whose transparency changes depending on a positional relationship with a viewpoint.

JP-A-2010-33252 is an example of the related art.

However, in the related art, there is a problem that a print preview cannot be provided for a printed matter in which a translucent fabric having transparency that changes within a surface due to fineness of a thread or roughness of a weave is used as a printing medium.

### SUMMARY

According to a first aspect of the present disclosure, there is provided a method of creating a print preview of a printed matter in which an image is printed on a printing medium that is a translucent fabric. The method includes (a) acquiring an image color channel representing the image, (b) acquiring medium texture information including a medium color channel representing unevenness of the printing medium and a medium alpha channel representing transparency of the printing medium, (c) calculating an albedo representing reflecting power of the printed matter using the image color channel and the medium alpha channel, (d) creating printed matter color data representing a color of the printed matter using the albedo and the medium color channel, and (e) creating the print preview by synthesizing a background with the printed matter color data using the medium alpha channel without using an alpha channel of the image.

According to a second aspect of the present disclosure, there is provided a print preview creation device that creates a print preview of a printed matter in which an image is printed on a printing medium that is a translucent fabric. The print preview creation device includes a memory and a processor. The processor is configured to execute processing (a) of acquiring and storing an image color channel representing the image in the memory, processing (b) of acquiring and storing medium texture information including a medium color channel representing unevenness of the printing medium and a medium alpha channel representing transparency of the printing medium in the memory, processing (c) of calculating an albedo representing reflecting power of the printed matter using the image color channel and the medium alpha channel, processing (d) of creating printed matter color data representing a color of the printed matter using the albedo and the medium color channel, and processing (e) of creating the print preview by synthesizing a background with the printed matter color data using the medium alpha channel without using an alpha channel of the image.

According to a third aspect of the present disclosure, there is provided a non-transitory computer-readable storage medium storing a computer program for creating a print preview of a printed matter in which an image is printed on a printing medium that is a translucent fabric. The computer program causes a computer to execute processing (a) of acquiring an image color channel representing the image, processing (b) of acquiring medium texture information including a medium color channel representing unevenness of the printing medium and a medium alpha channel representing transparency of the printing medium, processing (c) of calculating an albedo representing reflecting power of the printed matter using the image color channel and the medium alpha channel, processing (d) of creating printed matter color data representing a color of the printed matter using the albedo and the medium color channel, and processing (e) of creating the print preview by synthesizing a background with the printed matter color data using the medium alpha channel without using an alpha channel of the image.

### BRIEF DESCRIPTION OF THE DRAWINGS

FIG. 1 shows an example of a printed matter printed on a printing medium that is a translucent fabric.

FIG. 2 shows details of processing of creating a print preview.

FIG. 3 shows examples of handling of pixels according to values of an image color channel and an image alpha channel.

FIG. 4 schematically shows a state in which a printed matter is observed in a virtual space.

FIG. 5 shows a configuration of a printing system.

FIG. 6 shows a configuration of an image processing device.

FIG. 7 shows a configuration of a rendering unit.

FIG. 8 is a flowchart showing processing of the rendering unit.

### DESCRIPTION OF EMBODIMENTS

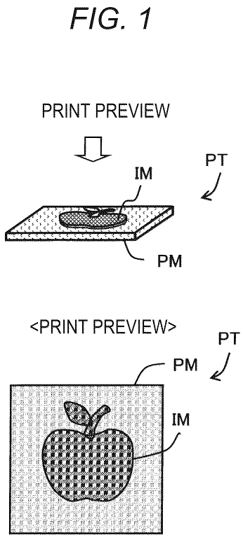

FIG. 1 shows details of processing of an embodiment. In the present embodiment, a print preview of a printed matter PT in which an image IM is printed on a printing medium PM that is a translucent fabric is created. The typical image IM is a color image.

The “translucent fabric” refers to a see-through fabric. As the translucent fabric, for example, woven fabrics such as chiffon, tulle, organdy, georgette, lace, mesh, lawn, and gauze can be used. These translucent fabrics have a characteristic that the transparency changes within the surface due to fineness of a thread and roughness of a weave. The printed matter PT obtained by printing an image on a translucent fabric is also referred to as a “translucent print fabric”. The translucent print fabric is, for example, a printed matter in which an image is printed on the translucent fabric using a textile printing machine.

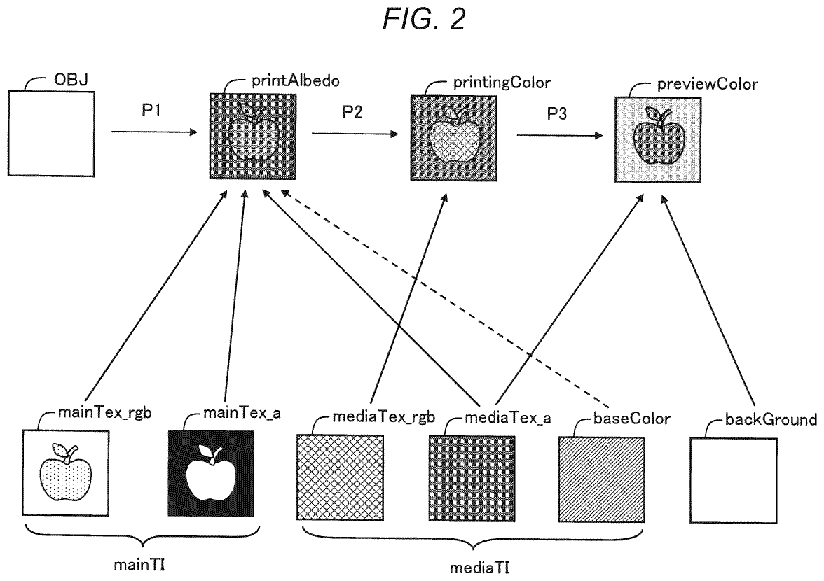

FIG. 2 shows details of processing of creating a print preview. In the present embodiment, the following resources are mainly used.

### (1) 3D Object OBJ (3-Dimensional Object)

A 3D object OBJ is a polygon object for creating a print preview previewColor as a 3D preview (3-Dimensional Preview) by performing rendering related to the printed matter PT. However, it is also possible to create the print preview previewColor as a 2D preview (2-Dimensional Preview) without using the 3D object OBJ. This point will be described later.

### (2) Main Texture Information MainTI

Main texture information mainTI includes an image color channel mainTex_rgb indicating a color of each pixel of the image IM and an image alpha channel mainTex_a indicating transparency of each pixel of the image IM.

### (3) Medium Texture Information MediaTI

Medium texture information mediaTI includes a medium color channel mediaTex_rgb indicating unevenness of each pixel of the printing medium PM, a medium alpha channel mediaTex_a indicating transparency of each pixel of the printing medium PM, and a base color baseColor of the printing medium PM. The medium color channel mediaTex_rgb is information representing unevenness of the printing medium PM and is an RGB image as an image format, and an RGB value indicates a normal direction of the unevenness instead of a color.

### (4) Background BackGround

Background backGround is an image of a background when the print preview previewColor is created.

The size of the image area of the medium texture information mediaTI is preferably the same as the size of the image area of the main texture information mainTI. However, there may be a case where the image area of the medium texture information mediaTI is smaller than the image area of the main texture information mainTI. In this case, it is preferable to dispose the medium texture information mediaTI in an area including the image area of the main texture information mainTI by arranging the same plurality of pieces of medium texture information mediaTI in a tiled pattern with no space between. In this way, the same medium texture information mediaTI can be applied to the main texture information mainTI of any size without enlarging the image area of the medium texture information mediaTI.

The color channels mainTex_rgb and mediaTex_rgb and the base color baseColor are preferably represented in a rendering color space. For example, sRGB is used as the rendering color space. The values α of the alpha channel mainTex_a and mediaTex_a have values in a range from 0 to 1. α=1 refers to complete opacity, and α=0 refers to complete transparency. The value α from 0 to 1 is a semantic numerical value and a real value.

A pixel for which the value (R, G, B) of the image color channel mainTex_rgb is (255, 255, 255) is either a white area to which white ink is applied or a non-printing area to which ink is not applied. Note that the RGB values are decimal notations of 8-bit data. Whether the white area or the non-printing area is determined according to the base color of the printing medium PM and the value of the image alpha channel mainTex_a.

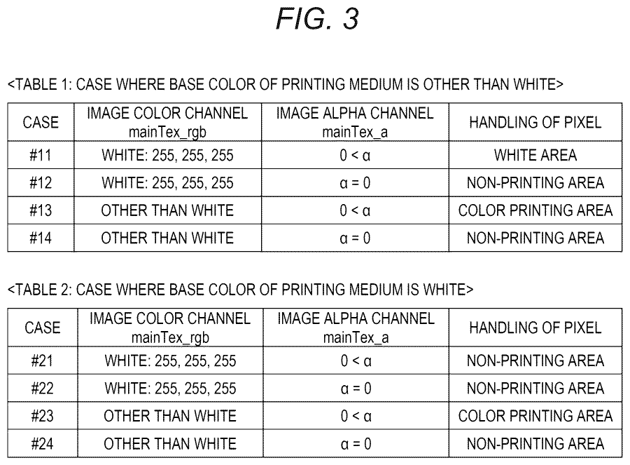

FIG. 3 shows examples of handling of pixels according to the values of the image color channel mainTex_rgb and the image alpha channel mainTex_a. Table 1 in FIG. 3 illustrates a case where the base color of the printing medium PM is other than white, and Table 2 illustrates a case where the base color of the printing medium PM is white. Table 1 is also applied to a case where the printing medium PM is transparent.

In the case where the base color of the printing medium PM is other than white, as shown in cases #11 and #12 of Table 1, a pixel in which the value of the image color channel mainTex_rgb is (255, 255, 255) is handled as a white area to which white ink is applied when 0<α, and is handled as a non-printing area to which ink is not applied when α=0. In this way, the case where the image color channel mainTex_rgb indicates the application of the white ink can be correctly reproduced. Further, as shown in cases #13 and #14, a pixel in which the value of the image color channel mainTex_rgb is not (255, 255, 255) is handled as a color printing area to which ink is applied when 0<α, and is handled as a non-printing area to which ink is not applied when α=0.

In the case where the base color of the printing medium PM is white, as shown in cases #21 and #22 of Table 2, a pixel in which the value of the image color channel mainTex_rgb is (255, 255, 255) is handled as a non-printing area to which ink is not applied regardless of the value α of the image alpha channel mainTex_a. The cases #23 and #24 in Table 2 are the same as the cases #13 and #14 in Table 1.

As shown in FIG. 2, the print preview previewColor is created by the following processing P1 to P3.

### Processing P1

In the processing P1, an albedo printAlbedo representing reflecting power of the printed matter PT is calculated using the image color channel mainTex_rgb, the image alpha channel mainTex_a, and the medium alpha channel mediaTex_a. The albedo printAlbedo has a data format of an RGB image, and thus can be considered to represent the color of the printed matter PT. When the base color baseColor of the printing medium PM is designated, the base color baseColor is also used to calculate the albedo printAlbedo. A method of calculating the albedo printAlbedo will be described later.

### Processing P2

In the processing P2, printed matter color data printingColor representing the color of the printed matter PT is created using the albedo printAlbedo and the medium color channel mediaTex_rgb. A method of calculating the printed matter color data printingColor will be described later.

### Processing P3

In the processing P3, the print preview previewColor is created by synthesizing the background backGround with the printed matter color data printingColor using the medium alpha channel mediaTex_a. In the processing P3, the image alpha channel mainTex_a is not used. A method of calculating the print preview previewColor will be described later.

The print preview previewColor created by the processing P1 to P3 reproduces a state in which the printing medium PM is not completely shielded by the ink even in a portion where the density of the image IM is high and the printing medium PM is maintained semitransparent. The reason why the printing medium PM is not completely shielded by the ink even in the portion where the density of the image IM is high is that the printing medium PM is a translucent fabric such as a thin fabric or a mesh fabric, and there is a gap portion where the ink is not placed or a portion where the ink is difficult to be placed. As will be described below, in the method of the present embodiment, it is possible to create a print preview previewColor that can successfully reproduce the semitransparent printing medium PM even in a portion where the density of the image IM is high, for the printed matter PT using the translucent fabric as the printing medium PM.

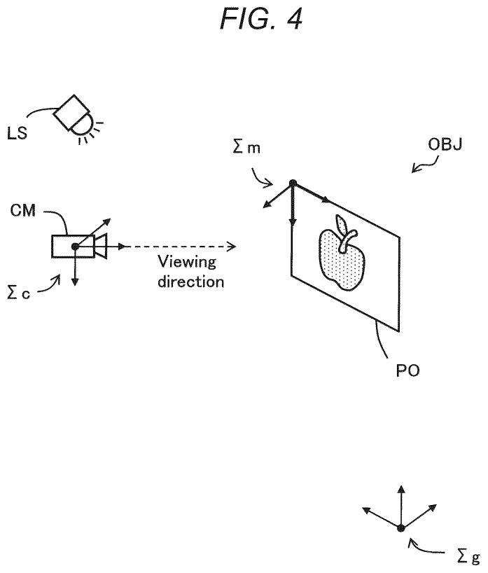

FIG. 4 schematically shows a state in which the printed matter PT is observed in a virtual space. The printed matter PT is represented using a 3D object OBJ. The 3D object OBJ may include one polygon, or may include a plurality of small polygons (micro polygons). When the 3D object is formed using a plurality of polygons, not only a rendering image of a planar printed matter but also a rendering image of a curved printed matter can be easily generated.

In FIG. 4, a local coordinate system Σm (also referred to as a model coordinate system) that is a three-dimensional orthogonal coordinate system of the 3D object OBJ, a world coordinate system Σg (also referred to as a global coordinate system) that is a three-dimensional orthogonal coordinate system of a virtual space, and a view coordinate system Σc (also referred to as a camera coordinate system) that is a three-dimensional orthogonal coordinate system of a camera CM placed in the virtual space are drawn as coordinate systems used for rendering processing. In the rendering processing, another coordinate system such as a screen coordinate system that is a coordinate system of a screen on which a scene viewed from the camera CM is projected is also used, however, the coordinate system is omitted in FIG. 3. In the rendering processing, an image obtained by observing the 3D object OBJ through the camera CM is generated as a rendering image, that is, a print preview previewColor.

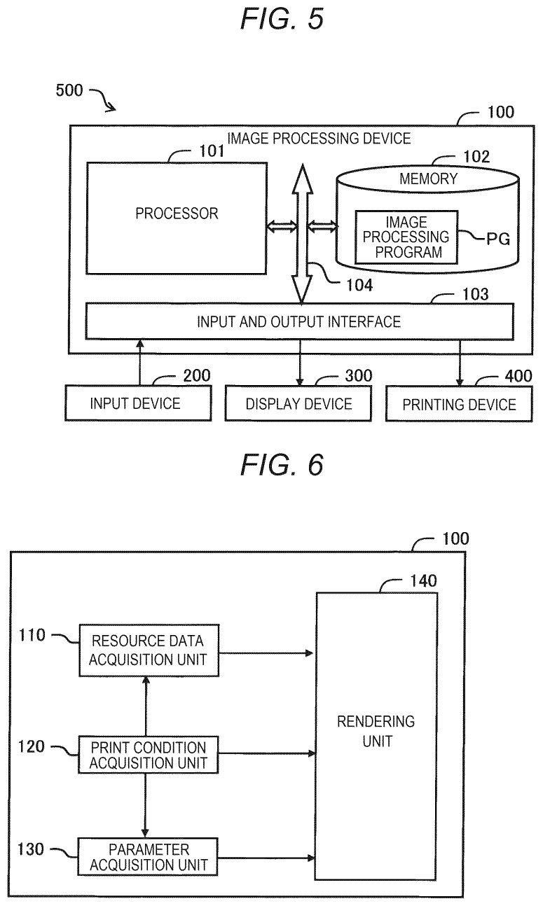

FIG. 5 shows a configuration of a printing system 500 including an image processing device 100 according to the embodiment. The printing system 500 includes the image processing device 100, an input device 200, a display device 300, and a printing device 400. The image processing device 100 generates a print preview previewColor, which is a rendering image representing the printed matter PT placed in the virtual space, by physical base rendering (hereinafter, simply referred to as rendering), and displays the print preview previewColor on the display device 300. The print preview previewColor can be displayed before execution of printing of the printed matter PT.

The image processing device 100 includes a processor 101, a memory 102, an input and output interface 103, and an internal bus 104. The processor 101, the memory 102, and the input and output interface 103 are coupled via the internal bus 104 communicably in both directions. The memory 102 includes a volatile memory including a main memory and a video memory, and a nonvolatile memory such as a hard disk and an SSD (Solid State Drive). The input device 200, the display device 300, and the printing device 400 are coupled to the input and output interface 103 of the image processing device 100 by wired communication or wireless communication. The input device 200 is, for example, a keyboard or a mouse. The display device 300 is, for example, a liquid crystal display. The input device 200 and the display device 300 may be integrated as a touch panel. The printing device 400 is, for example, an inkjet printer, and prints an image on a printing medium using a plurality of kinds of ink.

FIG. 6 shows a configuration of the image processing device 100. The image processing device 100 includes a resource data acquisition unit 110, a printing condition acquisition unit 120, a parameter acquisition unit 130, and a rendering unit 140. Functions of these units are implemented by software by the processor 101 executing an image processing program PG stored in advance in the memory 102. Some of the functions of the units may be implemented by hardware circuits.

The resource data acquisition unit 110 acquires the main texture information mainTI, the medium texture information mediaTI, and the background backGround illustrated in FIG. 2. These pieces of resource data may be stored in the memory 102 of the image processing device 100 or may be acquired from an external device via a network. The resource data acquired by the resource data acquisition unit 110 is transmitted to the rendering unit 140.

The printing condition acquisition unit 120 acquires printing conditions including the image IM used in printing and the type and size of the printing medium PM. The printing conditions preferably include other conditions such as the base color of the printing medium PM and the resolution of printing. The printing conditions acquired by the printing condition acquisition unit 120 are transmitted to the resource data acquisition unit 110 and the parameter acquisition unit 130. The resource data acquisition unit 110 and the parameter acquisition unit 130 respectively acquire resource data and parameters according to the printing conditions.

The parameter acquisition unit 130 acquires various parameters used for rendering. The various parameters used for rendering include, for example, 3D object information, camera information, illumination information, and the like. The 3D object information is a parameter related to the 3D object OBJ placed in the virtual space. The camera information is a parameter related to the position and the orientation of a camera CM placed in the virtual space. The illumination information is a parameter related to the type, position, orientation, color, and luminous intensity (light amount) of a light source LS placed in the virtual space. Examples of the type of the light source LS include a fluorescent lamp and an incandescent lamp. The parameters acquired by the parameter acquisition unit 130 are transmitted to the rendering unit 140.

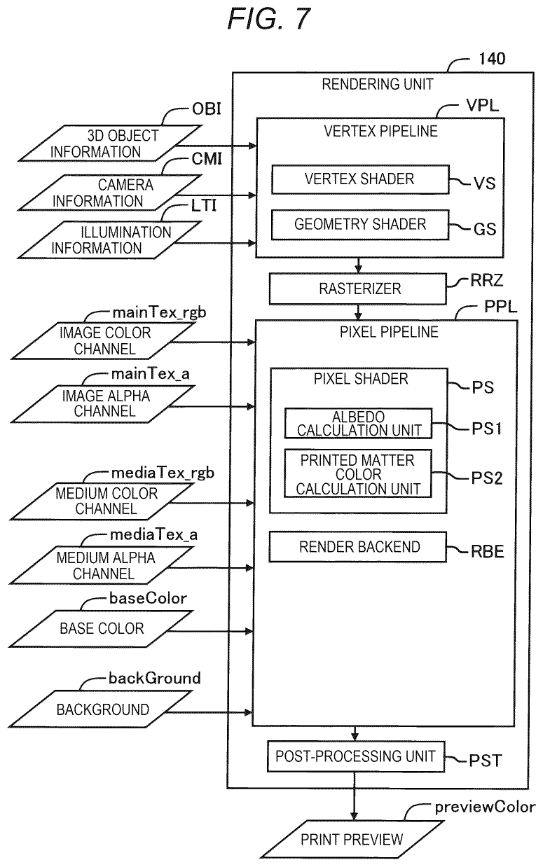

FIG. 7 shows a configuration of the rendering unit 140. The rendering unit 140 includes a vertex pipeline VPL, a rasterizer RRZ, a pixel pipeline PPL, and a post-processing unit PST. In the present embodiment, the vertex pipeline VPL includes a vertex shader VS and a geometry shader GS, and the pixel pipeline PPL includes a pixel shader PS and a render backend RBE.

The vertex shader VS executes processing related to polygons forming the 3D object OBJ using 3D object information OBI, camera information CMI, and illumination information LTI. This processing includes coordinate transformation of the vertices of each polygon forming the 3D object OBJ, calculation of a normal vector of each polygon, shading processing, calculation of texture mapping coordinates (UV coordinates), and the like. The coordinate transformation includes model transformation that is coordinate transformation from the local coordinate system Σm of the 3D object OBJ to the world coordinate system Σg, view transformation that is coordinate transformation from the world coordinate system Σg to the view coordinate system Σc, and projection transformation that is coordinate transformation from the view coordinate system Σc to the screen coordinate system. The result of processing by the vertex shader VS is transmitted to the geometry shader GS.

The geometry shader GS processes a set of vertices of the 3D object. The geometry shader GS can convert a polygon into a point or a line or convert a point or a line into a polygon by increasing or decreasing the number of vertices. The result of processing by the geometry shaper GS is transmitted to the rasterizer RRZ.

The rasterizer RRZ executes rasterization processing to generate drawing information for each pixel from the results of the processing by the vertex pipeline VPL. The result of processing by the rasterizer RRZ is transmitted to the pixel shaver PS.

The pixel shader PS executes lighting processing using the rasterized 3D object OBJ, the main texture information mainTI, and the medium texture information mediaTI to determine the pixel color of the 3D object OBJ corresponding to each pixel. The data representing the pixel color of the 3D object OBJ corresponds to the printed matter color data printingColor described with reference to FIG. 2.

In the present embodiment, the pixel shader PS includes an albedo calculation unit PS1 and a printed matter color calculation unit PS2.

The albedo calculation unit PS1 executes the processing P1 described with reference to FIG. 2. That is, the albedo calculation unit PS1 calculates the albedo printAlbedo representing the reflecting power of the printed matter PT using the image color channel mainTex_rgb, the image alpha channel mainTex_a, the medium alpha channel mediaTex_a, and the base color baseColor. Specifically, the albedo printAlbedo is calculated by the following expression

$$printAlbedo = ( mainTex\_rgb \times mainTex\_a + baseColor \times ( 1 - mainTex\_a ) ) \times mediaTex\_a . \qquad ( q1 )$$

When the base color baseColor is not designated, it is preferable that baseColor=1 is substituted in the expression (q1). This is because a white cloth is often used as the translucent fabric. The base color baseColor of the white cloth is RGB=(1, 1, 1).

The printed matter color calculation unit PS2 executes the processing P2 described with reference to FIG. 2. That is, the printed matter color calculation unit PS2 creates the printed matter color data printingColor representing the color of the printed matter PT using the albedo printAlbedo and the medium color channel mediaTex_rgb. Specifically, the printed matter color data printingColor is calculated by the following expression

$$printingColor = LightingFunction ( albedo , mediaTex\_rgb , light ) \qquad ( q2 )$$

where LightingFunction is a reflection function of light, and light is information of light such as color and direction of light.

A bidirectional reflectance distribution function can be used as the light reflection function. In general, the Disney principled BRDF is used. The result of processing by the pixel shader PS is transmitted to the render backend RBE.

The render backend RBE executes the processing P3 described with reference to FIG. 2 using the printed matter color data printingColor generated by the pixel shader PS. That is, the render backend RBE creates the print preview previewColor by synthesizing the background backGround with the printed matter color data printingColor using the medium alpha channel mediaTex_a. Specifically, the print preview previewColor is calculated by the following expression

$$previewColor = printingColor + backGround \times ( 1 - mediaTex\_a ) . \qquad ( q3 )$$

As can be understood from (q3), in the present embodiment, it is possible to create a print preview previewColor in which the background backGround is synthesized using the medium alpha channel mediaTex_a without using the image alpha channel mainTex_a. As described with reference to FIG. 2, since the image alpha channel mainTex_a is not used in the processing P3, it is possible to create the print preview previewColor that can successfully reproduce the semitransparent printing medium PM even in a portion where the density of the image IM is high, for the printed matter PT using the translucent fabric as the printing medium PM.

The post-processing unit PST performs post-processing such as anti-aliasing, ambient occlusion, screen space reflection, and depth of field processing on the print preview previewColor stored in the memory 102, thereby improving the appearance of the print preview previewColor.

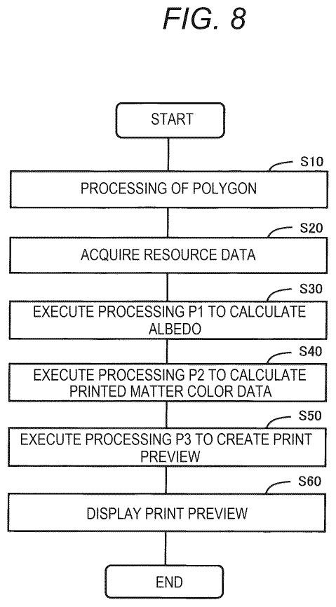

FIG. 8 is a flowchart showing processing of the rendering unit 140. In step S10, the vertex pipeline VPL executes processing related to the polygon object forming the 3D object OBJ.

In step S20, the pixel shader PS acquires resource data. The resource data includes the main texture information mainTI, the medium texture information mediaTI, and the background backGround shown in FIG. 2 according to the printing conditions designated by a user. The acquired resource data is stored in the memory 102.

When the image alpha channel mainTex_a is not designated by the user, the image alpha channel mainTex_a may be created according to the value of the image color channel mainTex_rgb. In this case, for example, α=0 may be set when the value of the image color channel mainTex_rgb is (255, 255, 255), and α=1 may be set when the value is other than (255, 255, 255).

In step S30, the albedo calculation unit PS1 of the pixel shader PS calculates the albedo printAlbedo by executing the processing P1 of FIG. 2 using the resource data acquired in step S20.

In step S40, the printed matter color calculation unit PS2 of the pixel shader PS calculates the printed matter color data printingColor by executing the processing P2 of FIG. 2.

In step S50, the render backend RBE calculates the print preview previewColor by executing the processing P3 of FIG. 2.

In step S60, the rendering image represented by the print preview previewColor is displayed on the display device 300.

According to the embodiment described above, it is possible to create the print preview previewColor for the printed matter PT using the translucent fabric in which the transparency changes within the surface due to the fineness of the thread or the roughness of the weave as the printing medium PM. Further, since the print preview previewColor is created without using the image alpha channel mainTex_a, it is possible to create the print preview previewColor that can successfully reproduce the semitransparent printing medium PM even in a portion where the density of the image IM is high.

In the above-described embodiment, the calculation of the albedo printAlbedo by the processing P1 of FIG. 2 is executed by the pixel shader PS, but the processing P1 may be executed as pre-processing prior to the rendering processing by the rendering unit 140.

The present disclosure is also applicable to a case where a print preview previewColor is created as a 2D preview instead of the 3D preview. The 2D preview can be created, for example, by any of the following methods.

### Method M1 of Creating 2D Preview

In the method M1, the printed matter color data printingColor is calculated with the fixed direction of the light represented by “light” as the information of light in the above expression (q2). The other processing is substantially the same as the processing of creating the 3D preview.

### Method M2 of Creating 2D Preview

In the method M2, in the processing P2 of FIG. 2, the printed matter color data printingColor is calculated by a method different from the expression (q2). For example, the printed matter color data printingColor may be created by applying texture application processing of applying the medium color channel mediaTex_rgb as a texture to the albedo printAlbedo. As the texture application processing, for example, the same processing as the processing disclosed in JP-A-06-86045 can be used. Specifically, a value obtained by multiplying the difference between the average value of the texture values and each texture value by a gain may be added to the pixel value of the albedo printAlbedo. Further, the medium color channel mediaTex_rgb may be applied as a texture according to another known method.

### Other Configurations

The present disclosure is not limited to the embodiments described above, and can be implemented in various forms without departing from the scope of the present disclosure. For example, the present disclosure may also be implemented in the following configurations. To solve a part or all of the problems of the present disclosure or to achieve a part or all of the advantages of the present disclosure, the technical features in the above-described embodiments corresponding to the technical features in the following aspects can be replaced or combined as appropriate. The technical features can be deleted as appropriate unless described as being essential in the specification.
(1) According to a first aspect of the present disclosure, there is provided a method of creating a print preview of a printed matter in which an image is printed on a printing medium that is a translucent fabric. The method includes (a) acquiring an image color channel representing the image, (b) acquiring medium texture information including a medium color channel representing unevenness of the printing medium and a medium alpha channel representing transparency of the printing medium, (c) calculating an albedo representing reflecting power of the printed matter using the image color channel and the medium alpha channel, (d) creating printed matter color data representing a color of the printed matter using the albedo and the medium color channel, and (e) creating the print preview by synthesizing a background with the printed matter color data using the medium alpha channel without using an alpha channel of the image.

According to the method, it is possible to create the print preview for the printed matter using the translucent fabric in which the transparency changes within the surface due to the fineness of the thread or the roughness of the weave as the printing medium. Further, since the print preview is created without using the alpha channel of the image, it is possible to create the print preview that can successfully reproduce a semitransparent printing medium even in a portion where the density of the image is high.
(2) In the above method, when the medium alpha channel is mediaTex_a, the background is backGround, the printed matter color data is printingColor, and the print preview is previewColor, (e) may be calculating the print preview in accordance with previewColor=printingColor+backGround×(1−mediaTex_a).

According to the method, it is possible to create the print preview synthesized with the background using the medium alpha channel without using the alpha channel of the image.
(3) In the above method, (d) may be creating the printed matter color data by applying a bidirectional reflectance distribution function to the albedo and the medium color channel.

According to the method, it is possible to create a good 3D preview in consideration of the direction of the light source.
(4) In the above method, the medium texture information may include a base color of the printing medium, and
   when the image color channel is mainTex_rgb, the alpha channel of the image is mainTex_a, the medium alpha channel is mediaTex_a, the base color is baseColor, and the albedo is printAlbedo, (c) may be calculating the albedo in accordance with printAlbedo=(mainTex_rgb×mainTex_a+baseColor×(1−mainTex_a))×mediaTex_a.

According to the method, the albedo can be calculated using the image color channel, the alpha channel of the image, and the medium alpha channel.
(5) According to a second aspect of the present disclosure, there is provided a print preview creation device that creates a print preview of a printed matter in which an image is printed on a printing medium that is a translucent fabric. The print preview creation device includes a memory and a processor. The processor is configured to execute processing (a) of acquiring and storing an image color channel representing the image in the memory, processing (b) of acquiring and storing medium texture information including a medium color channel representing unevenness of the printing medium and a medium alpha channel representing transparency of the printing medium in the memory, processing (c) of calculating an albedo representing reflecting power of the printed matter using the image color channel and the medium alpha channel, processing (d) of creating printed matter color data representing a color of the printed matter using the albedo and the medium color channel, and processing (e) of creating the print preview by synthesizing a background with the printed matter color data using the medium alpha channel without using an alpha channel of the image.
(6) According to a third aspect of the present disclosure, there is provided a non-transitory computer-readable storage medium storing a computer program for creating a print preview of a printed matter in which an image is printed on a printing medium that is a translucent fabric. The computer program causes a computer to execute processing (a) of acquiring an image color channel representing the image, processing (b) of acquiring medium texture information including a medium color channel representing unevenness of the printing medium and a medium alpha channel representing transparency of the printing medium, processing (c) of calculating an albedo representing reflecting power of the printed matter using the image color channel and the medium alpha channel, processing (d) of creating printed matter color data representing a color of the printed matter using the albedo and the medium color channel, and processing (e) of creating the print preview by synthesizing a background with the printed matter color data using the medium alpha channel without using an alpha channel of the image.

The present disclosure can also be implemented in various forms other than the method of creating a print preview, the print preview creation device, and the computer program. For example, the present disclosure can be implemented in the form of an image processing method or a non-transitory storage medium on which a computer program is recorded.

What is claimed is:

1. A method of creating a print preview of a printed matter in which an image is printed on a printing medium that is a translucent fabric, the method comprising:
(a) acquiring an image color channel representing the image;
(b) acquiring medium texture information including a medium color channel representing unevenness of the printing medium and a medium alpha channel representing transparency of the printing medium;
(c) calculating an albedo representing reflecting power of the printed matter using the image color channel and the medium alpha channel;
(d) creating printed matter color data representing a color of the printed matter using the albedo and the medium color channel; and
(e) creating the print preview by synthesizing a background with the printed matter color data using the medium alpha channel without using an alpha channel of the image.

2. The method according to claim 1, wherein
when the medium alpha channel is mediaTex_a, the background is backGround, the printed matter color data is printingColor, and the print preview is previewColor, (e) is calculating the print preview in accordance with previewColor=printingColor+backGround×(1−mediaTex_a).

3. The method according to claim 1, wherein
(d) is creating the printed matter color data by applying a bidirectional reflectance distribution function to the albedo and the medium color channel.

4. The method according to claim 1, wherein
the medium texture information includes a base color of the printing medium, and
when the image color channel is mainTex_rgb, the alpha channel of the image is mainTex_a, the medium alpha channel is mediaTex_a, the base color is baseColor, and the albedo is printAlbedo, (c) is calculating the albedo in accordance with printAlbedo=(mainTex_rgb×mainTex_a+baseColor×(1−mainTex_a))×mediaTex_a.

5. A print preview creation device that creates a print preview of a printed matter in which an image is printed on a printing medium that is a translucent fabric, the device comprising a memory and a processor, wherein
the processor is configured to execute:
processing (a) of acquiring and storing an image color channel representing the image in the memory;
processing (b) of acquiring and storing medium texture information including a medium color channel representing unevenness of the printing medium and a medium alpha channel representing transparency of the printing medium in the memory;
processing (c) of calculating an albedo representing reflecting power of the printed matter using the image color channel and the medium alpha channel;
processing (d) of creating printed matter color data representing a color of the printed matter using the albedo and the medium color channel; and
processing (e) of creating the print preview by synthesizing a background with the printed matter color data using the medium alpha channel without using an alpha channel of the image.

6. A non-transitory computer-readable storage medium storing a computer program for creating a print preview of a printed matter in which an image is printed on a printing medium that is a translucent fabric, the computer program causing a computer to execute:
processing (a) of acquiring an image color channel representing the image;
processing (b) of acquiring medium texture information including a medium color channel representing unevenness of the printing medium and a medium alpha channel representing transparency of the printing medium;
processing (c) of calculating an albedo representing reflecting power of the printed matter using the image color channel and the medium alpha channel;
processing (d) of creating printed matter color data representing a color of the printed matter using the albedo and the medium color channel; and
processing (e) of creating the print preview by synthesizing a background with the printed matter color data using the medium alpha channel without using an alpha channel of the image.
